(19) United States
(12) Patent Application Publication
(10) Pub. No.: US 2016/0020638 A1
(43) Pub. Date: Jan. 21, 2016

(54) PORTABLE CHARGING DEVICES

(71) Applicant: Incipio Technologies, Inc., Irvine, CA (US)

(72) Inventors: Timothy Hemesath, Long Beach, CA (US); Kenji Okada, Long Beach, CA (US); Carlos Del Toro, Irvine, CA (US); Lee Nguyen, Irvine, CA (US)

(21) Appl. No.: 14/801,572

(22) Filed: Jul. 16, 2015

Related U.S. Application Data
(60) Provisional application No. 62/075,203, filed on Nov. 4, 2014.
(60) Provisional application No. 62/026,595, filed on Jul. 18, 2014.

(51) Int. Cl. H02J 7/02; H02J 7/00

(52) U.S. Cl. CPC H02J 7/025; H02J 7/0042

(57) ABSTRACT

Portable charging devices for mobile devices such as cell/smart phones, computing tablets, MP3 players, gaming devices, and laptop computers and the like are disclosed. The devices may include a housing enclosing the circuitry and a cable extending from the housing on one end and terminating at a charging connector on the other end. The charging cable can wrap and unwrap around a groove or slot in the perimeter of the housing to facilitate different use modes, such as a storage mode, a rigid use mode, and a flexible cable use mode. The device may be in the form of a rechargeable battery bank and/or an inductive receiver and may be dimensioned so that when connected to the mobile device in rigid use mode, both the mobile device and charging device can lay substantially flat on the same supporting planar surface, such as a desk or table.

### INCORPORATION BY REFERENCE TO RELATED APPLICATIONS

This application claims the benefit of priority to U.S. Provisional Application Nos. 62/026,595, filed Jul. 18, 2014 and 62/075,203, filed Nov. 4, 2014. All of the above applications are hereby incorporated herein by reference in their entirety and are to be considered a part of this specification.

### BACKGROUND

1. Field of the Invention

This patent document relates to portable charging devices suited for charging portable or mobile consumer electronic devices such as cellular or smart phones, computing tablets, MP3 players, gaming devices, laptop computers, portable charging devices therefore, and the like. In particular such portable charging devices include inductive charging components such as inductive charging receivers or adapters and/or portable rechargeable battery banks.

2. Description of the Related Art

Inductive charging systems are known in the art. See U.S. Pat. No. 5,959,433A hereby incorporated by reference in its entirety. Inductive charging systems generally include an inductive transmitter that is plugged into a power source and drives power through an inductive circuit to an inductive receiver. FIG. 1 is a block diagram illustrating a representative architecture and circuit elements for a transmitter and receiver of an inductive wireless power charging system. FIG. 2 is another block diagram of representative architecture and circuit components of the inductive receiver component.

Conventional transmitters are typically in the form of a platform that is configured to reside or stand on top of a flat surface, such as a counter or desk. The charging surface, i.e., the surface adjacent to the inductive coil, typically faces upward and is elevated above the support counter or desk. When in use, the receiver is placed on top of a charging surface platform, which is connected via, for example, a power plug in a wall, so that it rests thereon in proximate contact therewith. Charge or power is then communicated or transmitted between the inductive coils positioned adjacent the proximately positioned charging surfaces on the transmitter and receiver.

Recently, it has been recognized by the inventors here that Starbucks and potentially other retailers and service providers are integrating inductive transmitter units into tables or countertops such that the charging surface is flush with the table or countertop. In order to facilitate user convenience, the inventors here recognized that there is a need to improve the construction and usability of the receiver unit to make it more compatible with the various transmitter configurations while also providing the desired functionality.

Similarly, portable battery banks are known and typically include a flexible cable to facilitate charging and recharging. FIG. 7 is a block diagram illustrating a representative architecture and circuit elements for a portable rechargeable battery bank. The inventors here recognized that there is a continuing need to improve the configuration of conventional portable inductive receiver components and battery banks to enhance user experience.

### SUMMARY

Portable charging devices for mobile devices such as cell/smart phones, computing tablets, MP3 players, gaming devices, and laptop computers and the like are disclosed. The devices include a housing enclosing the circuitry and a cable extending from the housing on one end and terminating at a charging connector on the other end. The charging connector may be any connector capable of communicating power and/or charging of the electronic device, e.g., USB, micro-USB, or 30 pin or 8 pin Lightening Apple proprietary connectors used in Apple products such as iPhones, iPads and iPods.

The charging cable can wrap and unwrap around a groove or slot in the perimeter of the housing to facilitate different use modes: (1) storage mode, wherein the charging cable is wrapped in a first direction and the connector tucked inwardly into a retention cavity formed within the perimeter of the housing, (2) a rigid use mode, wherein the charging cable is wrapped around the housing in a second direction and the charging connector is fixedly mounted outwardly to the housing, and (3) a flexible cable use mode, wherein the connector is neither fixedly positioned in either the storage or rigid use modes, but freely positionable.

The device may be in the form of a rechargeable battery bank and/or an inductive receiver and may be dimensioned so that when connected to the mobile device in rigid use mode, both the mobile device and charging device can lay substantially flat on the same supporting planar surface, such as a desk or table.

An additional input connector, such as a USB connector, can be included when the portable charging device is a battery bank to facilitate charging of the battery.

Various aspects described in connection with the embodiments of the inductive charging receiver disclosed herein, including the drawings and claims, may be combined to form claims for a device, apparatus, system, methods of manufacture and/or use in any way without limitation.

### BRIEF DESCRIPTION OF THE DRAWINGS

FIG. 1 is a block diagram illustrating a representative architecture and circuit elements for an inductive transmitter and receiver of an inductive wireless power charging system.

FIG. 2 is a block diagram of an illustrative architecture and circuit components of an inductive receiver.

FIGS. 3A-3B are annotated illustrations of a housing for a portable charging device. The movement of the charging cable from the storage position to the rigid or fixed use position is depicted to illustrate the different use modes.

FIGS. 4A-4C are perspective, top and cross-sectional views of the housing depicted in FIG. 3 in rigid use mode when the cable is fully wrapped around the housing and the connector is fixedly attached to the receiver housing in rigid or fixed use mode so as to reside external to the perimeter of the housing. The cross-sectional view depicted in FIG. 4C is taken along line A-A of FIG. 4B.

FIG. 5 depicts an inductive receiver employing to the housing depicted in FIGS. 3-4. The receiver is connected to an iPhone in fixed use mode and the iPhone is resting on a table with a built-in inductive transmitter under the receiver.

FIG. 6 shows a mobile device that is connected to the inductive charging receiver employing the housing illustrated in FIGS. 3-5. The receiver is connected to an iPhone in free floating cable mode. The receiver is resting on an elevated inductive transmitter platform relative to the surface supporting the iPhone.

FIG. 7 is a block diagram illustrating a representative architecture and circuit components for a rechargeable battery bank that is enclosed in a housing, such as that illustrated in FIGS. 3-5 and FIGS. 8A-8B.

FIGS. 8A-8B are annotated illustrations of another housing for a portable charging device. The movement of the charging cable from the storage position to the rigid or fixed use position is depicted to illustrate different use modes.

FIG. 9 depicts an embodiment of a portable charging device that includes a retention clip that is mounted on the top side of the charging device to allow the user to clip to the housing personal items such as money, credit cards, and the like.

### DETAILED DESCRIPTION

Features, aspects and advantages are described below with reference to the drawings, which are intended to illustrate but not to limit the invention. In the drawings, like reference characters denote corresponding features consistently throughout similar embodiments.

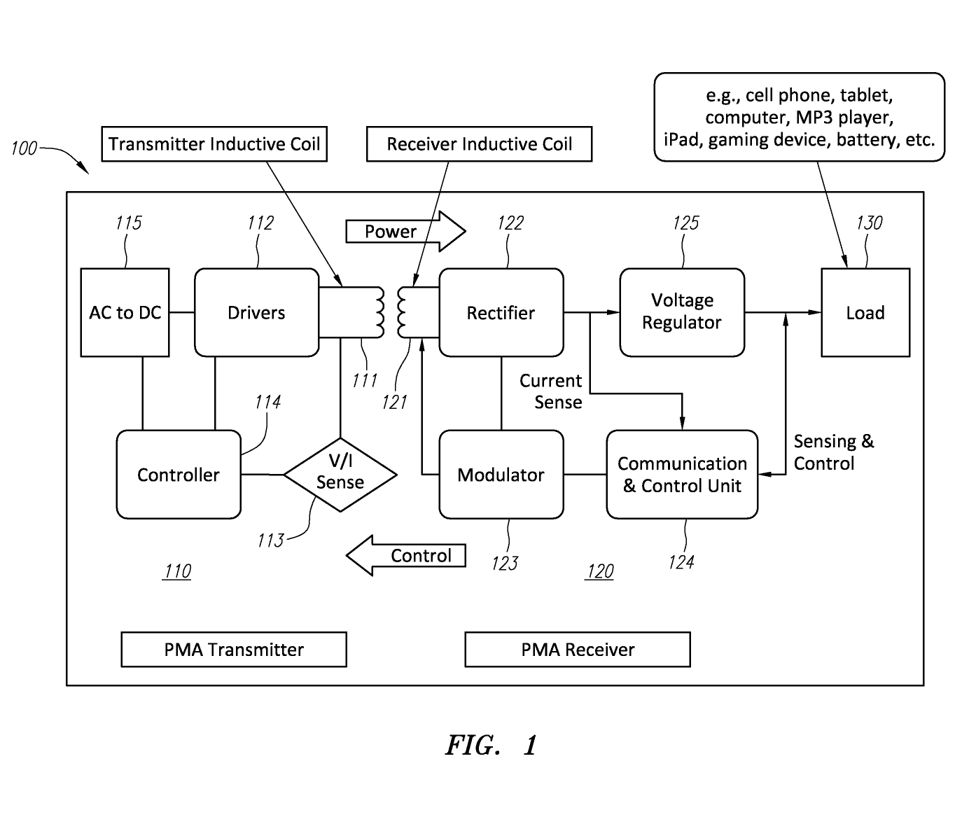

FIG. 1 is a block diagram illustrating representative architecture and circuit elements for an inductive transmitter 110 and inductive receiver 120 of an inductive wireless power charging system 100. The inductive transmitter 110 and inductive receiver 120 are typically housed in separate enclosures. The circuitry of the inductive transmitter 110 includes a transmitter inductive coil 111 that is connected to one or more drivers 112, a voltage/current sensor 113, a controller 114, and an AC/DC converter 115 that together generate and control the current being driven through the inductive coil 111. The circuitry of the inductive receiver 120 includes a receiver inductive coil 121, that is connected to a rectifier 122, a modulator 123, a communication and control unit 124, and voltage regulator 125, which together modulate, rectify and control the current induced in the receiver inductive coil 121 for transmission to the load 130 (e.g., handheld/portable a cell phone, a smart phone, a computing tablet like an iPad, a laptop, a MP3 player, or a gaming device, etc.).

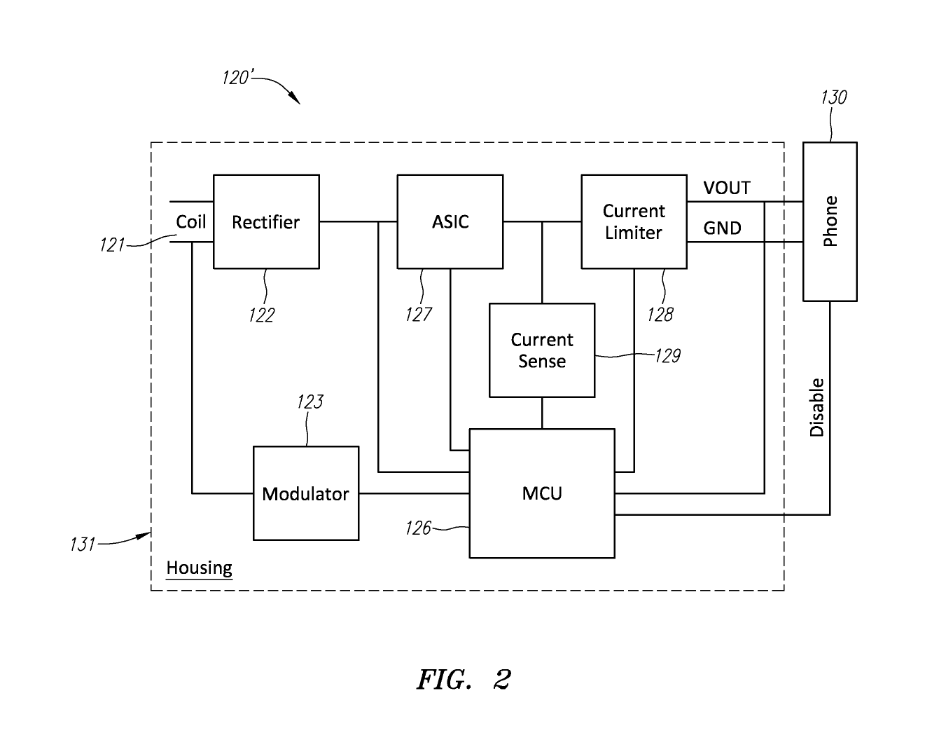

FIG. 2 is a block diagram of another representative architecture and circuit components of the receiver component 120′ that also includes a receiver inductive coil 121, a rectifier 122, and a modulator 123 and further specifies an MCU (micro control unit) 126, an ASIC (application specific integrated circuit) 127, a current sensor 129, and a current limiter 128, which together modulate, rectify and control the current induced in the receiver inductive coil 121 for transmission to the load 130 (e.g., identified as a phone). The dashed line around the circuit represents the enclosure or housing 131 that contains the inductive receiver circuitry. It should be understood that while the load 130 may be a phone, tablet, or other handheld device that is contained within a separate housing, the load 130 may also be a rechargeable battery or battery bank that is contained within the inductive receiver housing 131 or outside the inductive receiver housing 131 in a separate external stand-alone housing. When the inductive receiver also contains a rechargeable battery then in operation the current from the inductive coil 121 would charge the rechargeable battery, which in turn could be connected to an external device like a phone, tablet, MP3 player laptop or gaming device for purposes of charging that device.

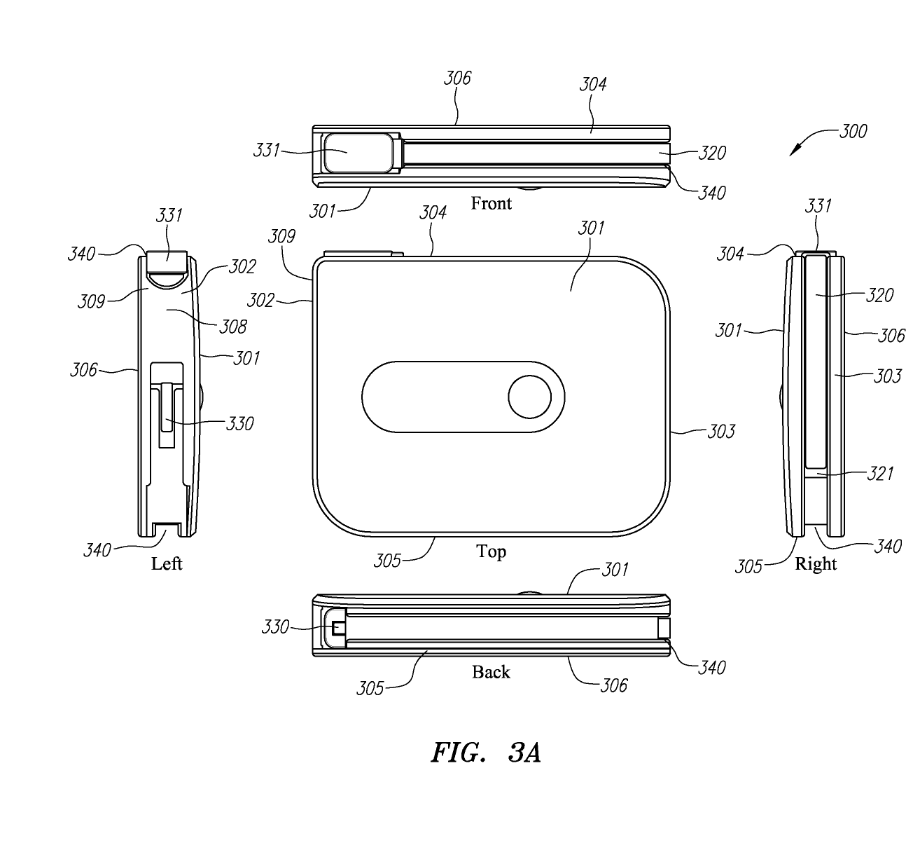

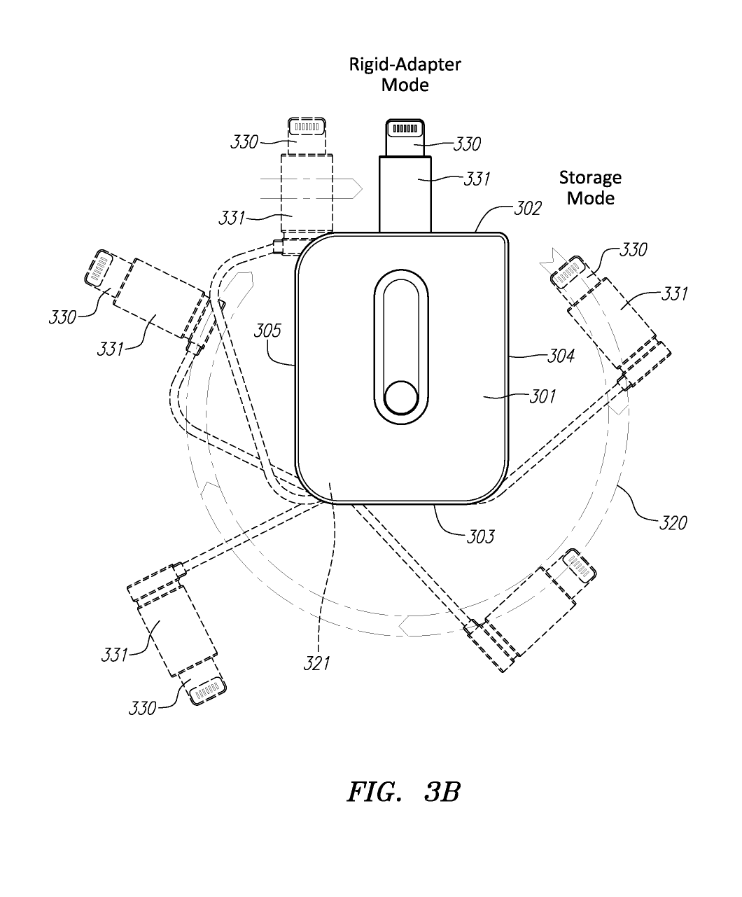

FIGS. 3A-3B are annotated compilation illustrations of a first housing embodiment implemented for a wireless inductive charging adapter or receiver 300. The receiver 300 includes a built-in cable 320 that can be concealed within the housing in a storage mode when the cable 320 is fully wrapped in a first direction, rigidly fixed or positioned in a rigid use mode, when the cable 320 is fully wrapped around the housing 310 in a second direction opposite the first direction, and a flexible cable use mode when the cable 320 is partially unwrapped but not locked into position in either storage or rigid use mode.

FIG. 3A depicts different views of a representative inductive charging receiver (or inductive charging adapter) housed in a rectangular shaped parallelepiped housing 310, which functions to enclose the receiver circuitry, such as the components depicted in FIG. 1 and FIG. 2 and/or described in connection thereto. FIG. 3A includes a top view (centrally positioned) and corresponding left, right, front and back side views of the inductive charging receiver 300, which illustrate the top, left, right, front, back and bottom surfaces or sides 301, 302, 303, 304, 305, 306 respectively of the receiver 300. The bottom side or surface 306 of the receiver 300 has basically the same dimensions as the top side 301 and is positioned parallel to and opposed to the top side 301. The receiver 300 also includes a charging cable 320 that is connected to the output of the receiver circuitry on one end and a charging connector 330 on the other end that is adapted to being connected to the charging port or connection of an electronic device such as a smart phone, tablet, lap top, portable rechargeable battery, gaming device and may be a USB, micro-USB or other connector capable of communicating power and/or charging of the electronic device such as the 30 pin and 8 pin Apple proprietary connectors used in Apple iPhones, iPads and iPods.

The housing 310 includes a groove 340 that is formed around the perimeter of the housing 310 into the sides 302, 303, 304, 305 of the housing 310. The groove 340 is defined by walls structures on the underside of the top and bottom sides 301 and 306 and recessed regions in the left, right, top, and bottom sides 302, 303, 304, and 305. The groove 340 is dimensioned to receive the charging cable 320 when the cable is wrapped around the perimeter of the housing 310 in the storage and/or use positions as further described.

FIG. 3A depicts the receiver 300 with the charging cable 320 in storage position. The charging cable 320 is wrapped counterclockwise (when viewing the receiver from the top side 301) into the groove 340 that is formed into the sides of the perimeter of the receiver 300. In the illustrated implementation the groove is dimensioned to fully receive (e.g., all or more than half) the cable 320 so that the cable is housed entirely or substantially within the groove and/or internal to the outer perimeter of the housing 310. By so doing, the housing 310 is capable of providing greater protection from impact and/or damage to the cable 320 and connector 330 while still allowing the cable 320 to readily wrap and unwrap around the housing 310. It should be understood that the cable 320 can be housed only partially within the groove 340.

The charging connector 330 includes a connector housing 331 to provide firm support to the connector 330. In the storage position depicted in FIG. 3A, the housing 331 of the connector 330 is tucked into a retention or storage cavity 308 that is formed within the perimeter of the housing on the left side 302 of the housing 310. The retention cavity 308 is dimensioned such that the charging connector 330 and connector housing 331 are exposed on either end to facilitate the user's insertion and removal of the charging connector 330 and connector housing 331 from the storage cavity 308. As illustrated, the storage cavity 308 is positioned on a first end region 309 of the left side 302 and is dimensioned to receive and retain the charging connector 330 and its housing 331 in a fixed storage position relative to the main receiver housing 310. A notch can be included in the storage cavity 308 to allow the user more ready access to the connector housing 331 to ease removal and insertion into the storage cavity 308.

FIG. 3B depicts the movement of the charging cable 320 from the storage position to the rigid or fixed use position to illustrate the different use modes of the representative charger receiver 300. Specifically, FIG. 3B illustrates the wrapping and unwrapping of the charging cable 320 around the housing 310 and the corresponding position of the charging connector 330 and connector housing 331.

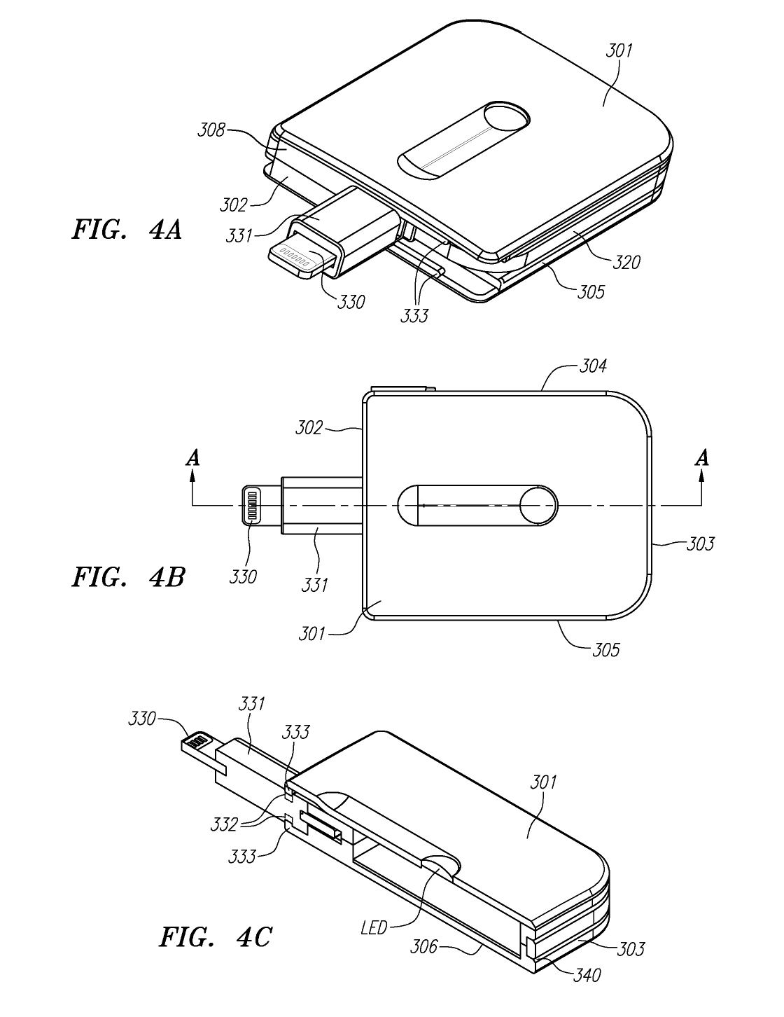

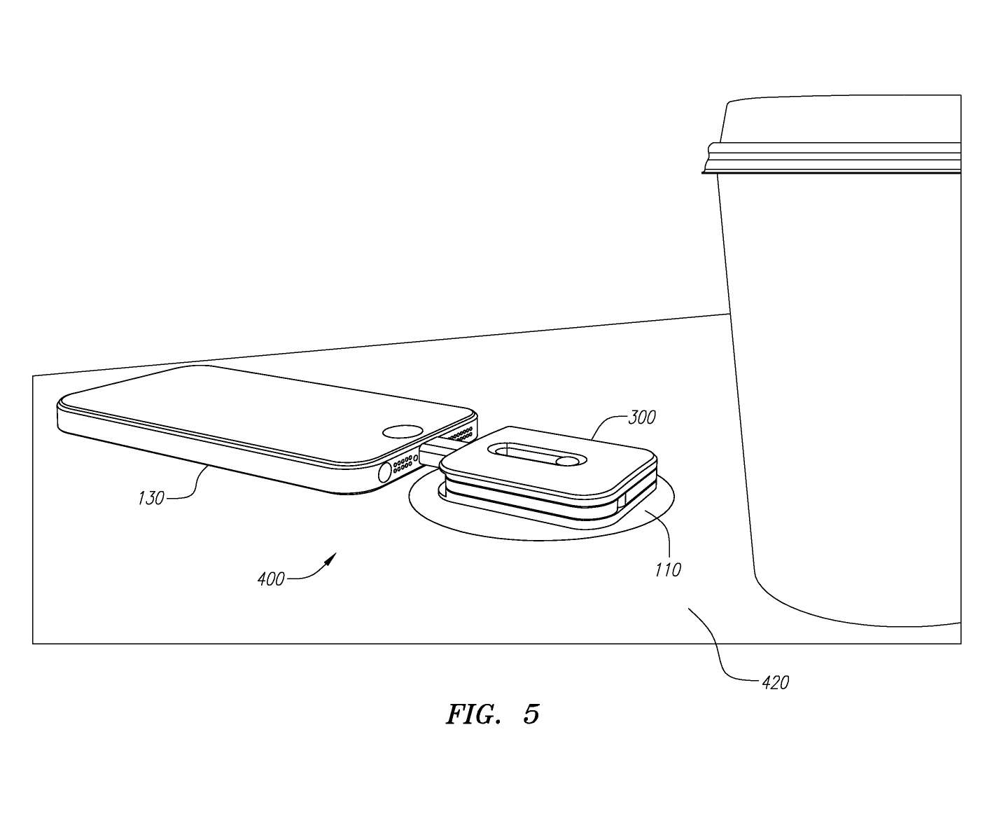

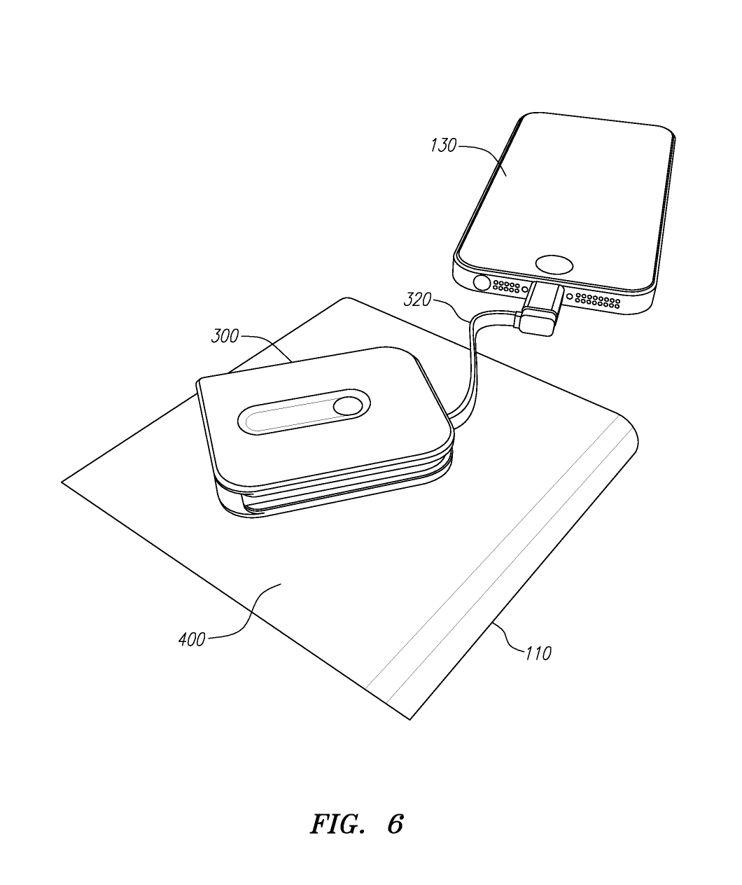

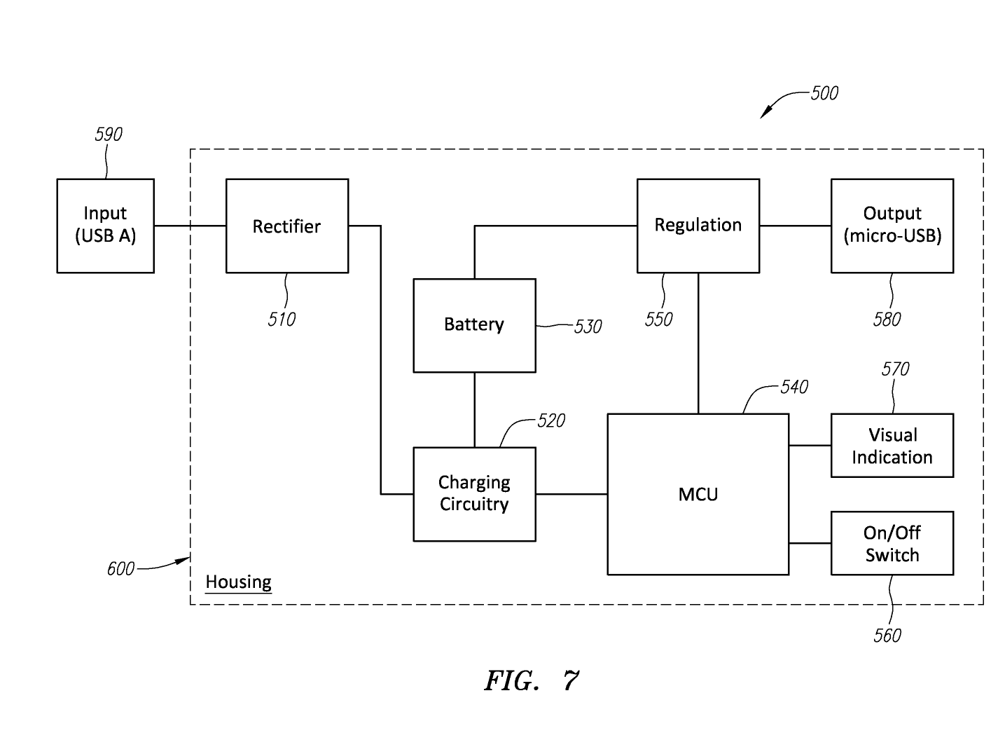

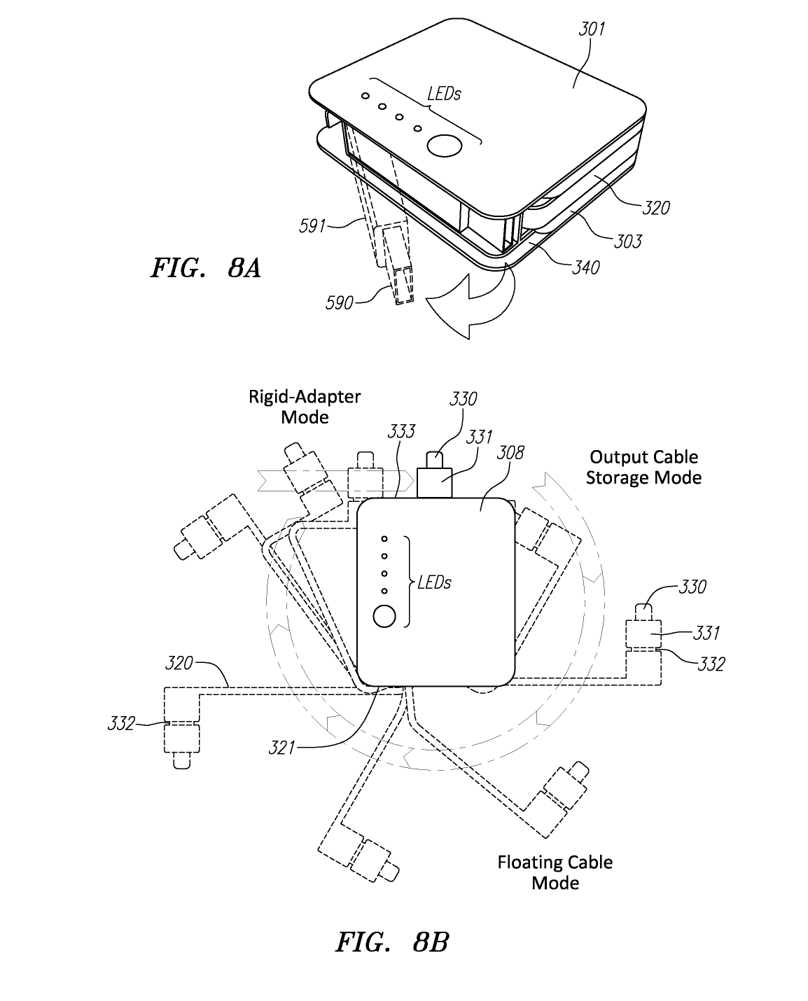

The different use modes include: (1) the storage mode, as also illustrated in FIG. 3A, and previously described above when the cable 320 is fully wrapped in a first direction and the housing 331 is inserted into the storage cavity 308, (2) a rigid use mode, as also illustrated in FIGS. 4A-4B and FIG. 5, when the cable 320 is fully wrapped around the housing 310 in a second direction opposition of the first so that the connector 330 is fixedly attached to the receiver housing, and (3) a flexible or free-floating cable mode, as also illustrated in FIG. 6, when the connector 330 is removed from the storage cavity 308 and the cable 320 is partially unwrapped and not in either the storage mode or the rigid use adapter mode.

As shown FIG. 3B, when the charging cable 320 is fully wrapped around the housing 310 in the counterclockwise direction, at around the 1 o'clock position, the inductive charging receiver 300 can be put into, or configured into, the storage mode by mounting or inserting the charging connector 330 and connector housing 331 into the retention cavity 308 of the inductive charging receiver housing 310. This storage mode conveniently provides a small/compact and portable configuration of the inductive charging receiver 300 with built-in cable that is, among other things, user and travel-friendly.

When the cable 320 is wrapped around the cable connection point 321 in the clockwise (i.e., the opposite direction), slots 332, that are formed on the charging connector 330 or housing 331 thereof, can be inserted into rails 333 (best illustrated in FIGS. 4A and 4B) so as to configure the receiver 300 into the rigid or fixed use mode. Notably, the slots 332 of the connector 330 can slide on the rails 333 into final position so that the cable 320 is pulled taunt into the groove 340 and thereby protected within the groove by the housing 310.

When the charging receiver 300 is in the rigid adapter mode (or fixed use mode) (as shown in FIG. 3B and also FIGS. 4A-C and FIG. 5), the receiver may be dimensioned for use or to charge a particular mobile device such that when receiver and the mobile device (or load) 130 are connected to one another in fixed use mode and laid on a flat surface both the mobile device and the receiver unit are supported by the flat surface along the same plane, for example, as illustrated in FIG. 5. In this way, both receiver 300 and the mobile device (e.g., iphone) can be firmly supported by the table or flat supporting surface, which can improve charging functionality by assuring proper contact between charging surfaces while also mitigating undue stress on the connection between the mobile device and the receiver. In the illustrated embodiment, this functionality is obtained by dimensioning the receiver to be the same thickness as the mobile device and having the connector 330 be centrally positioned, when in rigid mode, so as to be at the same height as the connection port on the mobile device for which the receiver is intended to charge.

Alternatively, it should be understood that the inductive receiver 300 may be dimensioned thicker or thinner in height (i.e., height is defined in this respect as between the top and bottom surfaces 301 and 306), and the connector 330 may be positioned in the rigid use position off-center relative thereto so that when both the connector 330 and/or the receiver 300 and the mobile device are set on a flat surface the charging port on the mobile device and the connector 330 are aligned at an equal distance above the supporting surface.

In addition, it should also be understood that the connector 330 may, alternatively or in combination with the foregoing configurations, be configured to be adjustable relative to the height of the receiver 300. For example, in one implementation, the connector housing 331 may include slots 332 that are dimensioned deeper (illustrated in shadow in FIG. 4C) to allow adjustment on the rails 333, upward or downward relative to the top and bottom surfaces 301 and 306 of the receiver 300, when in the fixed use mode position so that a singularly height dimensioned receiver 300 can be used with multiple mobile devices 130 of differing height dimensions and/or charging port positions, while still allowing both the receiver 300 and device or load 130 to be supported on or by the same planar surface (e.g., by the same table) and the connector 330 to be aligned with the charging port of the device 130. Thus, in this configuration the height position of the connector 330 can be adjustable relative to the bottom and top surfaces 301 and 306 of the housing 310. Multiple sets of slots having different locations relative to the housing may be included to allow for adjustability.

Other implementations to facilitate adjustability may include different types of mechanical slides that facilitate up and down movement of the housing that that allows the receiver housing to be positioned in different heights. In another embodiment, the charging receiver housing may include folding legs attached to the bottom of the housing 310 so that when the legs are unfolded, the receiver housing 310 has a height that is higher than that when the legs are folded. The later implementation however, may create a larger gap between the receiver 300 and the charging surface 400 by elevating the bottom of the receiver 300 above the charging surface 400 and thus create a greater separation between the inductive coils 111 and 121 of the transmitter and receiver which could diminish power transmission therebetween.

Use of protective cases tends to increase the effective height of mobile device by elevating the bottom of the device. Thus, the off-center and adjustable connector or receiver implementations may in addition to accommodating mobile devices with different height dimensions, may also be particularly well suited or useful in situations where the receiver 300 is used to charge mobile devices that are encased in a protective case (e.g., a case for a smart phone).

The charging cable 320 is also preferably dimensioned lengthwise so that it has limited, or no, slack so that it is not loose, but rather is relatively taut, when wrapped in the groove 340 of the housing 310 in both the storage and rigid charging use mode. The length of the cable 320 together with the perimeter location of the rails 333, the storage cavity 308, and the cable attachment point 321 allow a single length cable 320 to be concealed within the groove 340 in both fixed use and storage modes as illustrated in the drawings and described herein. Specifically, in the illustrated embodiment, the cable attachment point 321 is positioned circumferentially mid-way along the perimeter between the center of the housing cavity 308 and the center of the final position of the fixed or rigid use mode position and the cable is thus dimensioned in accordance therewith. When the cable 320 is wrapped around the cable connection point 321 in the clockwise (i.e., the opposite direction), the charging connector 330 is hanging freely (as shown in around 2-11 o'clock positions) and the charging receiver is in a flexible or free-floating cable mode. In this flexible or free-floating cable mode, the cable is extended out from the housing 310 of the charging receiver 300 to allow charging in situations where bottom surface of a load (e.g., cell phone, tablet, computer, MP3 player, iPad, gaming device, etc.) is differ in relative elevation from the bottom surface of the charging receiver. Thus, as illustrated in FIG. 6, the charging receiver 300 can be resting on an elevated charging transmitter base 110 while also being connected to a mobile device 130 that rests on a surface below that which the charging receiver 300 rests upon.

FIG. 4A-4C depicts a perspective view, top view, and cross-sectional view (across line A-A depicted in FIG. 4B), respectively, of the housing 310 of the receiver unit 300 illustrated in FIGS. 3A-3C when the receiver 300 is in the rigid mode use configuration.

Notably, while certain circuit components are described herein, it should be understood that the inductive receiver 300 may employ or support any wireless power standard including PMA and Qi. In addition, in some embodiments the wireless inductive charging receiver 300 can provide dual wireless functionality by supporting existing PMA and Qi technology as well as bring enhanced charging through PMA-3 specifications. In addition to the technological advantage, an easy to use device is provided that is both convenient and stylish as well as removing any restrictions for a charging platform design. The features include build-in cable, cable mounted to charger for flat surfaces (such as at Starbucks), and cable expendable to accommodate charging pads. In addition, a built-in LED is provided to indicate when wireless power is received.

As previously noted, FIG. 5 shows a mobile device 130 in the form of an iPhone connected in fixed use mode to the inductive charging receiver 300. The inductive charging receiver 300 is placed on top of an inductive charging transmitter 110 that is integrated in a table 420 so that the inductive charging surface 400 of the transmitter 110 is flush with the table 420. Thus, in operation when a user is not using the phone the bottom surface 306 of the inductive charging receiver 300 is placed in proximate contact with the top surface 400 of the inductive charging transmitter 110 and is charging the user's phone or other mobile device 130. At the same time the bottom of the phone 130 is also being supported by the same table 420 on the same plane adjacent to the inductive charging surface 400 of the transmitter 110 that is mounted flush therewith. When the user receives a phone call, the user can pick up the mobile device 130 with the charging receiver 300 fixedly attached thereto and thereby avoid hassling with a receiver dangling therefrom or unplugging the receiver 300 from the phone. Usability and convenience is thereby enhanced.

FIG. 6, as previously noted further shows a mobile device 130 that is connected in flexible or free-floating cable mode to the inductive charging receiver 300. The inductive charging receiver 300 is placed on top of an inductive charging base (or charging pad) such that the charging surface 400 is higher than the bottom surface of the load or phone. The free cable allows the receiver and the phone to be supported on different planes, such as when the user is at home and wants to charge their device mobile device using a conventional inductive charging systems having an elevated platform or base. By utilizing both PMA-3 and Qi wireless charging technology, high compatibility between wireless charging devices can be provided. The LED indicator light can inform the user of when the receiver 300 is receiving wireless power. Thus, whether a user is their mobile device at home using a conventional charging base or making a quick table top stop at a local coffee shop, the charging receiver 300 described herein can provide a convenient and user friendly means for charging and using your mobile device 130 without worrying about lost, dangling or tangled cables

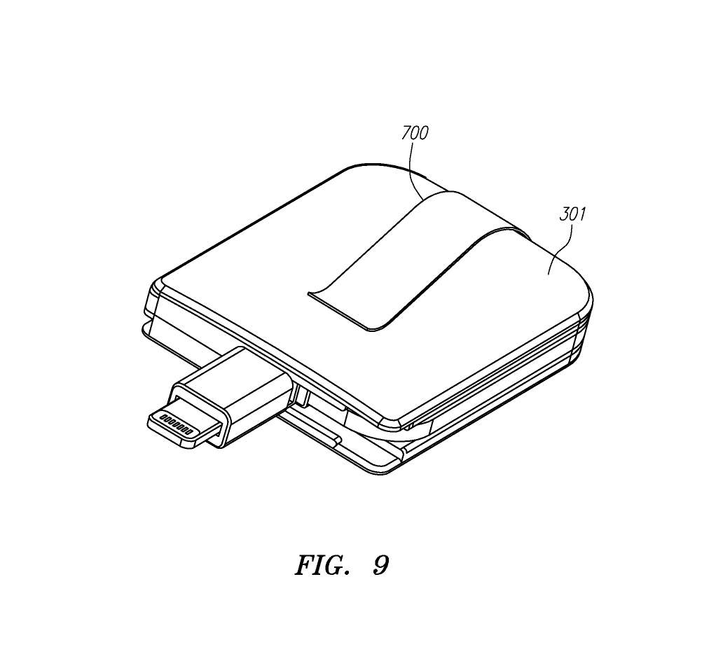

FIG. 7 is a block diagram illustrating a representative architecture and of circuit components for a rechargeable battery bank 500 that is enclosed in a housing 600. The housing such as that illustrated in FIGS. 3-6 and described above or as depicted in FIGS. 8A-B and described in connection therewith. Generally the rechargeable battery bank 500 includes a rectifier 510 that receives power from an input 590 such as a USB Type A connector, a charging circuit that is connected to the rectifier that facilitates recharging of the battery 530. A micro controller unit (MCU) 540 and regulation circuit 550 control the charging 520 and output 580 of the battery 530. The output connector can be, for example, an Apple Lightning or a micro-USB connector. In addition, an visual indicator 570 such as an LED indicator light 570 can provide the user with information regarding the charge and charging or discharging status of the battery bank 500. An on/off switch 560 can also be connected to the MCU 540 to turn on and off the battery bank 500. Such battery bank circuits are known in the art.

The input and the output 590 and 580 while illustrated as separate components may use a common physical connector so that the same connector can receive charge to recharge the battery 530 and output charge thereby depleting the battery 530 to charge a mobile device such as a cell phone. Alternatively, the input and output 590 and 580 may be separate and/or different physical connectors such as previously described.

FIGS. 8A-8B depict another embodiment of a portable charging device similar to that depicted in FIGS. 3-6 described previously. FIG. 8A illustrates a perspective view of a portable charging device in the form of a battery bank 500 that includes a built in charging cable 320 while FIG. 8B depicts the movement of the charging cable 320 from the storage position to the rigid or fixed use position to illustrate the different use modes of the representative charger receiver 300. The configuration of the housing 310 is basically the same as that illustrated in FIGS. 3-6 and described except that on the left side an additional USB charging input cable 591 and input or connector 590 is provided to facilitate charging of the battery 530. Additional LED indicator lights or visual indicators 570 may be included to provide indication regarding the operation and the relative charge in the battery charger, e.g., the more lights the more charge. The same reference numerals from FIGS. 3-6 are provided to denote corresponding features in FIGS. 8A-8B.

FIG. 9 depicts an embodiment where the portable charging device includes a money clip 700 that can be mounted on the top side 301 of the charging device.

It should be understood, however, that the various aspects and teachings therein are not limited to any particular mobile device having wide applicability or any specific coffee shop or store that provides free wireless charging service. Accordingly, it should be understood that any of the features or components described herein may be combined in any combination.

What is claimed is:

1. A wireless inductive charging adapter comprising:
a housing having a top surface, an opposing bottom surface, and sidewalls extending between said bottom and top surface;
electronic circuitry for receiving inductive power including an inductor coil mounted within said housing adjacent to the bottom surface thereof; and
a cable connected to the housing at a connection point on one end and having a connector on the other end, wherein when the cable is connected to said housing the cable electrically connects the circuitry to the adapter so that power from said electronic circuitry can be transmitted through the cable to the connector.

2. The wireless inductive charging adapter of claim 1, wherein the connection end may be tethered, fixed or removably connected to the housing at the connection point.

3. The wireless inductive charging adapter of claim 2, wherein the housing further being dimensioned around its outer perimeter with a groove that is dimensioned to receive the cable and protect the cable when the cable is wrapped around the housing.

4. The wireless inductive charging adapter of claim 3, wherein the groove being defined in the sidewalls of the housing and including a slot built therein on a first end of the groove and a connector storage compartment on the other end of the groove.

5. The wireless inductive charging adapter of claim 4, wherein the connector being dimensioned such that when the cable is wrapped around the housing within the groove in a first direction the outside of the connector is adapted to being inserted within the slot into a fixed position with the exposed electrical conductors of the connector pointing away from the housing, and such that when the connector is wrapped around the housing within the groove in a second opposing direction, the connector can be positioned within the connector storage compartment such that it does not protrude beyond the perimeter of the housing.

6. The wireless inductive charging adapter of claim 1, wherein the housing further comprises an adjustment mechanism adapted to provide adjustable heights to the housing.

7. A portable charging device for mobile devices, the charging device comprising:
a housing enclosing electronic circuitry; and
a cable extending from the housing on one end and terminating at a charging connector on the other end, wherein the cable wraps and unwraps around a groove formed within the perimeter of the housing to facilitate different operation modes.

8. The charging device of claim 7, wherein when the charging cable is fully wrapped in a first direction, the connector is dimensioned so that it can be received within a retention cavity formed within the perimeter of the housing.

9. The charging device of claim 8, wherein when the charging cable is fully wrapped around the housing in a second direction opposite to the first direction, the charging connector is dimensioned so that it can be fixedly mounted to the housing and positioned external to the housing perimeter.

10. The charging device of claim 7, wherein when the cable is unwrapped from the housing, the connector is not fixedly attached to the housing.
